(19) United States
(12) Patent Application Publication
(10) Pub. No.: US 2019/0146527 A1
(43) Pub. Date: May 16, 2019

(54) Dome-Loaded Pressure Regulator

(71) Applicant: Witt GmbH & Co. Holding und Handels-KG, Witten (DE)

(72) Inventor: Martin Bender, Dortmund (DE)

(73) Assignee: Witt GmbH & Co. Holding und Handels-KG, Witten (DE)

(21) Appl. No.: 16/098,548

(22) PCT Filed: May 3, 2017
(86) PCT No.: PCT/EP2017/060495

§ 371 Date: Nov. 2, 2018

(30) Foreign Application Priority Data
May 6, 2016 (DE) 10 2016 108 448.4

(51) Int. Cl. G05D 16/06; G05D 16/18

(52) U.S. Cl. CPC G05D 16/0636; G05D 16/185

(57) ABSTRACT

A dome pressure regulator for regulating gas pressure, having a housing (1), a fixed valve seat (10), a movable valve body (8), a closing spring (9) acting on the valve body (8), and a diaphragm (4) which is connected to the valve body (8) and which is able to be subjected to a control pressure, settable via a gas pressure spring, in the opening direction and to a secondary pressure in the closing direction. The object of the invention is to detect state parameters of the system and to integrate continuous functionality checking and logging of the collected measurement values into the pressure regulator. In order to achieve said object, the invention proposes at least one travel sensor (15), by way of which the stroke of the valve body (8) is measurable, and a sensor-system evaluation unit (17) integrated into the housing.

The invention relates to a dome pressure regulator for regulating gas pressure, having a housing, a fixed valve seat, a movable valve body, a closing spring acting on the valve body, and a diaphragm which is connected to the valve body and which is able to be subjected to a control pressure, settable via a gas pressure spring, in the opening direction and to a secondary pressure in the closing direction.

A dome pressure regulator of said type is known. By contrast with numerous other pressure regulators, this dome pressure regulator does not work with a mechanical spring, but rather with a gas pressure spring which is settable via a control gas. Either the gas to be regulated or a separate gas may be used as a control gas. The required secondary pressure can be set via the gas pressure spring. The primary and secondary pressures are each detected and indicated via a mechanical manometer. Furthermore, the secondary pressure at the outlet of the dome pressure regulator is routed via a control line into a dome chamber situated between the diaphragm and the diaphragm plate. If deviations in the secondary pressure then occur, the same pressure is immediately established in the dome chamber. Since the pressure in the dome chamber counteracts the pressure of the gas pressure spring via the diaphragm, the valve is opened further when the secondary pressure drops and closed further when the secondary pressure rises, with the result that ultimately the desired secondary pressure is established again. In the case of deviations which are no longer able to be compensated by way of this measure, the secondary pressure can be set anew via the gas pressure spring.

Due to the feedback of the secondary pressure into the dome chamber, such a dome pressure regulator is very well suited for compensating for deviations in the secondary pressure owing to varying consumption or varying inlet pressures. Even in the case of extremely high or low flow rates, said regulator exhibits very stable regulating behavior. Almost exact regulation is possible even in the case of large pressure differences, and so an otherwise conventional two-step solution is no longer necessary in most cases. As soon as another working pressure is required at the extraction point on the secondary side or the gas temperature and/or ambient temperature changes significantly, it is possible for the secondary pressure to be readjusted via the control pressure of the gas pressure spring, is possible.

One problem of such a dome pressure regulator is that, through the measurement of primary and secondary pressures, only indication of the current pressure at the dome pressure regulator via manometers and readjustment of the secondary pressure, if appropriate via the control pressure of the gas pressure spring, is possible. However, it is possible only to a very limited extent to establish the trigger for the deviation of the working pressure on the basis of the two measurement values here. Moreover, continuous monitoring of such a dome pressure regulator is not possible or is possible only with additional effort. Consequently, temporary deviations in the working pressure and possible temporary faults in the pressure systems positioned upstream and downstream, or in the dome pressure regulator itself, are not detected. An event diagnosis is therefore almost impossible.

Specifically the constant advances in automation and the demands on gas pressure systems in industrial processes, which are becoming greater and more complex, make it essential for functionality checking, functionality logging and event diagnosis which are as extensive and prompt as possible to be realized.

It is therefore the object of the invention to provide a dome pressure regulator which is able to automatically detect further useful state parameters of the system, and to integrate continuous functionality checking and logging of the collected measurement values into the dome pressure regulator.

In order to achieve said object, proceeding from a dome pressure regulator of the type mentioned in the introduction, the invention proposes providing at least one travel sensor, by way of which the stroke of the valve body is measurable, and a sensor-system evaluation unit integrated into the housing.

The integration of an additional travel sensor allows detection of the instantaneous valve body deflection. Due to these additional state parameters, it is possible for the quantitative variations in the system to be inferred. Here, a capacitive, inductive, magnetic or optical travel sensor, for example, is suitable as a travel sensor. The sensor evaluation unit registers the measurement values of the travel sensor. In this way, the quantitative variations in the pressure system of the dome pressure regulator can be logged over a continuous extensive time period and with little effort, so that these can be evaluated by the user at a later stage.

One refinement of the invention provides that at least one electronic pressure sensor which is connected to the sensor-system evaluation unit and which serves for detecting the primary pressure and/or the secondary pressure is additionally provided. This sensor system allows further measurement data to be collected. By means of said measurement data, not only the variations in the pressure system in quantitative terms but also the cause thereof can be inferred. The additional measurement data are likewise registered by the sensor evaluation unit.

It is thus possible for variations in the pressure system positioned upstream to be established via an electronic pressure sensor which detects the primary pressure, while irregularities in the dome pressure regulator itself are detected via the measurement data of an electronic pressure sensor which detects the secondary pressure.

It is also expedient for a temperature sensor which is connected to the sensor-system evaluation unit and which serves for detecting the ambient temperature around the dome pressure regulator to be provided. Since the dome pressure regulators are used under different and especially also greatly varying climatic conditions, the influence of the ambient temperature on the variations in the overall pressure system can be detected via the additional temperature sensor.

It is also expedient for at least in each case one temperature sensor which is connected to the sensor-system evaluation unit and which serves for detecting the temperature of the primary-side and/or the secondary-side gas to be provided. The additional measurement of the gas temperatures allows the flow rate and thus the gas consumption to be determined in a more accurate manner and continuously, with the result that leaks or other undesirable gas losses can be established by way of unusual consumption values.

One refinement provides that a pressure sensor which is connected to the sensor-system evaluation unit and which serves for detecting the control pressure and a temperature sensor which serves for detecting the temperature of the control gas are provided. By way of the measurement values here, it is possible for abnormalities in relation to the control pressure regulator to be registered.

One preferred embodiment of the dome pressure regulator provides that the sensors are connected to the sensor-system evaluation unit and are integrated in or on the housing of the dome pressure regulator. Due to this measure, the installation of the dome pressure regulator remains simple since no additional wiring effort for connecting the sensors to the sensor-system evaluation unit results during the installation of the dome pressure regulator.

Expediently, the measurement data of the evaluation unit are retrievable via an interface arranged on the dome pressure regulator. This may be realized by a graphical interface, or else by a simple hardware interface. It is thus possible to represent the different profiles of the state parameters, if appropriate correlation curves or event histories in the case of limit values being exceeded or fallen below. Due to this measure, maintenance measures are much more effective and thus able to be carried out more frequently and more precisely. Moreover, from the measurement data acquired, it is possible to infer the wear status of the dome pressure regulator and also of the systems positioned upstream and downstream.

It is particularly expedient for the interface arranged on the dome pressure regulator to be a radio interface. This radio interface, integrated as an alternative or in addition to the graphical interface, allows the data to be retrieved also via a wireless display module carried by maintenance personnel, such as a smartphone or a tablet PC. Remote maintenance or automatic remote monitoring of the dome pressure regulator via said interface would also be conceivable with a correspondingly available data network.

An exemplary embodiment of the invention will be explained in more detail below on the basis of drawings, in which:

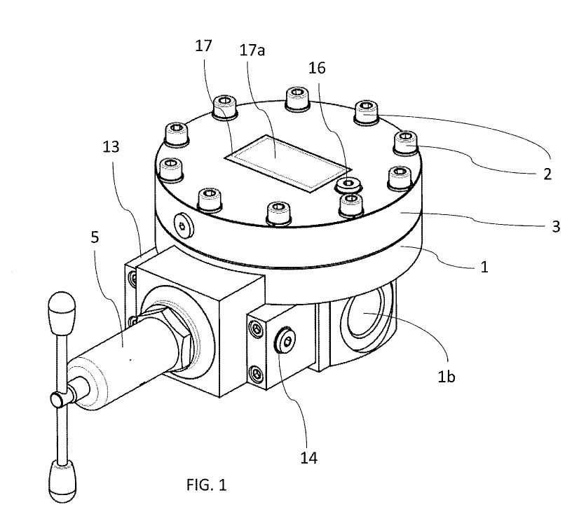

FIG. 1 schematically shows a 3D view of a dome pressure regulator according to the invention,

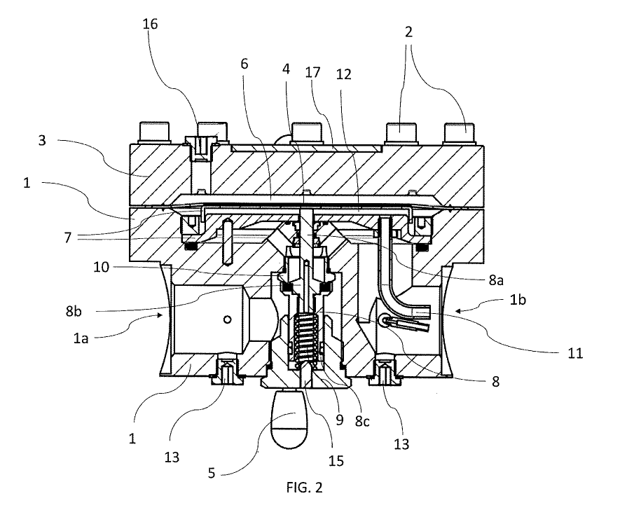

FIG. 2 schematically shows a longitudinal section through the dome pressure regulator in the closed switching state from FIG. 1.

In the drawings, the housing of the dome pressure regulator is denoted by the reference sign 1. The housing 1 has a primary-side attachment end 1a, which can be connected to an incoming pipeline (not illustrated) of a pressure distribution system positioned upstream, and a secondary-side attachment end 1b, to which a pressure distribution system positioned downstream (likewise not illustrated) or, directly, an end consumer can be connected. Furthermore, the housing 1 is connected to a housing cover 3 by means of screws 2. A diaphragm 4 is mounted in a pressure-tight manner between the housing 1 and the housing cover 3. Said diaphragm 4 is composed of an elastomer.

Furthermore, a drive 5 is illustrated. In this exemplary embodiment, said drive 5 is operated manually. An electrical or pneumatic drive would also be possible, however. The pressure at the secondary-side attachment end 1b can be set by means of a control gas via the drive 5. Either the gas to be regulated or a separate gas may be used as a control gas. The control gas is for this purpose conducted into a pressure chamber 6 situated between the diaphragm 4 and the housing cover 3. The diaphragm 4, which is subjected to the pressure of the control gas, transmits its stroke to a valve body 8 via a two-part diaphragm plate 7. The valve body 8 is composed of a valve shaft 8a, a valve plate 8b and a valve tappet 8c.

In the closed switching state illustrated in FIG. 2, the valve body 8 blocks the flow of gas through the dome pressure regulator in that it presses the valve plate 8b against a valve seat 10 by means of a closing spring 9. If the control gas pressure is then increased to such an extent that the force of the closing spring 9 is overcome, the valve body 8 is moved away from the valve seat 10 and the dome pressure regulator opens. The secondary pressure at the secondary-side attachment end 1b can then be set to the target value via a further increase in the control pressure. The stroke of the valve body 8 is limited by the form of the diaphragm plate 7.

The secondary pressure is transmitted through a control line 11 into a dome chamber 12 situated between the housing 1 and the diaphragm 4 or diaphragm plate 7. The secondary pressure in the dome chamber 12 is thus coupled against the control pressure in the pressure chamber 6. If variations then occur in the system, for example as a result of a change in the primary pressure or in the temperature, and the secondary pressure rises or drops, the dome pressure regulator closes or opens further, with the result that the target pressure is established on the secondary side again. If the variations in the system become too great or the boundary conditions are changed permanently and significantly, the secondary pressure has to be set anew via the drive 5.

According to the invention, in this exemplary embodiment, various sensors are additionally installed at the dome pressure regulator, via which various system parameters can be detected. A primary-side combined pressure/temperature sensor 13 detects the primary pressure and the temperature of the gas at this position. Significant changes or else temporary variations in the measurement values here suggest a change in the pressure system positioned upstream of the dome pressure regulator. Furthermore, a secondary-side combined pressure/temperature sensor 14 detects the secondary pressure and the temperature of the gas at this position. Significant changes in the secondary-side measurement values here with simultaneously constant primary-side measurement values suggest a malfunction of the dome pressure regulator.

Furthermore, a travel sensor 15 which detects the stroke of the valve tappet 8c is provided. It is possible via this additional travel sensor 15 for the flow through the dome pressure regulator to be determined relatively accurately. If unusual values occur for the flow values, the cause is chiefly attributable to the pressure system positioned downstream or to the end consumer.

Finally, a combined pressure/temperature sensor 16 for detecting the control pressure is also provided. By means of the measurement values here, the correct function of the control pressure regulator including the drive 5 can be fully monitored.

In order for the measurement data to be registered, the sensors 13, 14, 15 and 16 are connected to a sensor-system evaluation unit 17.

According to the embodiment, the sensor-system evaluation unit 17 may log entire measurement series or else just capture set limit value exceedances or other events which are of particular interest. In this exemplary embodiment, the sensor-system evaluation unit 17 already has a display 17a for representing the measurement logs integrated. Instead of the display, another interface for reading out and evaluating the measured data would also be possible. The interface could also be realized for example in the form of a simple hardware interface to which the operating and maintenance personnel are able to connect a mobile device via a connection cable. A further possibility would be a radio interface (for example NFC, Bluetooth, etc.) or an optical interface (for example IR), via which measurement values are able to be read out.

### LIST OF REFERENCE SIGNS

1 Housing
1a Primary-side fitting end
1b Secondary-side fitting end
2 Screw
3 Housing cover
4 Diaphragm
5 Drive
6 Pressure chamber
7 Diaphragm plate
8 Valve body
8a Valve shaft
8b Valve plate
8c Valve tappet
9 Closing spring
10 Valve seat
11 Control line
12 Dome chamber
13 Pressure/temperature sensor (on primary side)
14 Pressure/temperature sensor (on secondary side)
15 Travel sensor
16 Pressure/temperature sensor (control pressure)
17 Sensor-system evaluation unit
17a Display

1. A dome pressure regulator for regulating gas pressure, having a housing, a fixed valve seat, a movable valve body, a closing spring acting on the valve body, and a diaphragm which is connected to the valve body and which is able to be subjected to a control pressure, settable via a gas pressure spring, in the opening direction and to a secondary pressure in the closing direction, further comprising at least one travel sensor, by way of which the stroke of the valve body is measurable, and a sensor-system evaluation unit integrated into the housing.

2. The dome pressure regulator as claimed in claim 1, further comprising in each case at least one electronic pressure sensor which is connected to the sensor-system evaluation unit and which serves for detecting the primary pressure and/or the secondary pressure.

3. The dome pressure regulator as claimed in claim 1, further comprising a temperature sensor which is connected to the sensor-system evaluation unit and which serves for detecting the ambient temperature around the dome pressure regulator.

4. The dome pressure regulator as claimed in claim 2, further comprising at least in each case one temperature sensor which is connected to the sensor-system evaluation unit and which serves for detecting the temperature of the primary-side and/or secondary-side gas.

5. The dome pressure regulator as claimed in claim 1, further comprising a pressure sensor which is connected to the sensor-system evaluation unit and which serves for detecting the control pressure, and by a temperature sensor which serves for detecting the temperature of the control gas.

6. The dome pressure regulator as claimed in claim 1, wherein all the sensors are integrated in or on the housing of the dome pressure regulator.

7. The dome pressure regulator as claimed in claim 1, wherein the measurement data of the evaluation unit are retrievable via an interface arranged on the dome pressure regulator.

8. The dome pressure regulator as claimed in claim 8, wherein the interface arranged on the dome pressure regulator is a radio interface.
